(19) United States
(12) Patent Application Publication
(10) Pub. No.: US 2024/0255677 A1
(43) Pub. Date: Aug. 1, 2024

(54) VIEWING-ANGLE DIFFUSION FILM, MANUFACTURING METHOD THEREOF, AND DISPLAY DEVICE

(71) Applicant: SUZHOU CHINA STAR OPTOELECTRONICS TECHNOLOGY CO., LTD., Suzhou (CN)

(72) Inventors: Ding LI, Suzhou (CN); Junjie LI, Suzhou (CN); Dan CAO, Suzhou (CN)

(73) Assignee: SUZHOU CHINA STAR OPTOELECTRONICS TECHNOLOGY CO., LTD., Suzhou (CN)

(21) Appl. No.: 18/313,320

(22) Filed: May 6, 2023

(30) Foreign Application Priority Data
Jan. 30, 2023 (CN) 202310071643.4

(51) Int. Cl. G02B 5/02

(52) U.S. Cl. CPC G02B 5/0242; G02B 5/0268

(57) ABSTRACT

A viewing-angle diffusion film includes an optical material layer and a plurality of optical parts. The optical material layer has a light emitting surface and a light incident surface disposed opposite to each other and parallel to each other. The plurality of optical parts are disposed in an array in the optical material layer, and the plurality of optical parts have long axes and short axes intersecting each other. A refractive index of each of the plurality of optical parts is greater than a refractive index of the optical material layer, and an angle between each of the long axes of each of the plurality of optical parts and the light emitting surface of the optical material layer is greater than or equal to 0 degree and less than or equal to 45 degrees.

### FIELD OF THE DISCLOSURE

The present application relates to the technical field of display technologies, and more particularly, to a viewing-angle diffusion film, a manufacturing method thereof, and a display device.

### BACKGROUND

With the rapid development of display technologies, the market has higher and higher requirements for the resolution of display panels. However, the higher the resolution of the display panel, the worse the performance of display brightness corresponding to the large viewing angle of the display panel. In the prior art, in order to improve the display performance of the display device at a large viewing angle, the display performance at a large viewing angle is consistent with the display performance at a front view. The industry usually uses a viewing-angle expansion functional film layer to improve the display performance at a large viewing angle by adjusting outgoing light of the front view and the large viewing angle.

At present, the viewing-angle expansion functional film layer mainly includes a low-refraction resin layer and a high-refraction resin layer. Through the low refraction resin layer, the high refraction resin layer, and a graphic section between the two, the adjustment of the outgoing light in the front view and the large viewing angle is realized. In the traditional method of making the high refraction resin layer, it is usually necessary to use a nano-cutting machine tool for processing. Moreover, after the high refraction resin layer is formed by embossing the mold, it is very easy to cause damage to the high refraction resin layer during the demolding process. Therefore, in the traditional method of manufacturing the viewing-angle expansion film layer, there are issues such as long mold manufacturing cycle, low efficiency, and poor yield, which seriously affect the mass production of the product.

### SUMMARY

### Technical Problem

Embodiments of the present application provide a viewing-angle diffusion film, a manufacturing method thereof, and a display device, so as to alleviate deficiencies in related technologies.

In order to achieve the above objects, the technical solutions provided by the embodiments of the present application are as follows:

An embodiment of the present application provides a viewing-angle diffusion film, comprising:
an optical material layer having a light emitting surface and a light incident surface disposed opposite to each other and parallel to each other;
a plurality of optical parts disposed in an array in the optical material layer, wherein the plurality of optical parts have long axes and short axes intersecting each other;
wherein a refractive index of each of the plurality of optical parts is greater than a refractive index of the optical material layer, and an angle between each of the long axes of each of the plurality of optical parts and the light emitting surface of the optical material layer is greater than or equal to 0 degree and less than or equal to 45 degrees.

In the viewing-angle diffusion film provided in the embodiment of the present application, a shape of each of the plurality of optical parts is cylindrical, the plurality of the optical parts are disposed in an array in the optical material layer, and extending directions of the long axes of the plurality of the optical parts are parallel to each other.

In the viewing-angle diffusion film provided in the embodiment of the present application, a ratio of a length of each of the long axes of each of the plurality of optical parts to a length of each of the short axes of each of the plurality of optical parts is greater than 5 and less than 30, wherein the length of each of the short axes of each of the plurality of optical parts is greater than 0.8 microns, and the length of each of the long axes of each of the plurality of optical parts is less than a thickness of the optical material layer.

In the viewing-angle diffusion film provided in the embodiment of the present application, the refractive index of each of the plurality of optical parts is greater than or equal to 1.4 and less than or equal to 1.7, and the refractive index of the optical material layer is greater than or equal to 1.3 and less than or equal to 1.6.

In the viewing-angle diffusion film provided in the embodiment of the present application, a range of a difference between the refractive index of each of the plurality of optical parts and the refractive index of the optical material layer is greater than 0.02.

In the viewing-angle diffusion film provided in the embodiment of the present application, in two adjacent ones of the plurality of optical parts, an orthographic projection of each of the plurality of optical parts on a light incident surface of the optical material layer and an orthographic projection of another of the plurality of optical parts on the light incident surface of the optical material layer are at least partially overlap.

In the viewing-angle diffusion film provided in the embodiment of the present application, a material of the optical material layer is one of polyethylene, polypropylene, polyvinyl alcohol, polycarbonate, polyacrylic acid, or polyethylene terephthalate.

An embodiment of the present application provides a manufacturing method of a viewing-angle diffusion film, comprising following steps:
providing an optical material and a plurality of optical parts;
mixing the optical material with the plurality of optical parts, such that the plurality of the optical parts are located in the optical material, wherein a refractive index of each of the plurality of optical parts is greater than a refractive index of the optical material, and the plurality of optical parts have long axes and short axes intersecting each other;
stretching the optical material along a preset direction to form an optical material layer, and arranging the plurality of optical parts in an array in the optical material layer, wherein an angle between each of the long axes of each of the plurality of optical parts and the light emitting surface of the optical material layer is greater than or equal to 0 degree and less than or equal to 45 degrees.

In the manufacturing method provided in the embodiment of the present application, a stretching ratio of the optical material is greater than 1.01.

An embodiment of the present application provides a display device comprising a display panel and any of the viewing-angle diffusion films described above, wherein the viewing-angle diffusion film is disposed on a light emitting surface of the display panel.

Beneficial effects of the embodiments of the present application: The embodiments of the present application provide a viewing-angle diffusion film, a manufacturing method thereof, and a display device. The display device includes a display panel and the viewing-angle diffusion film. The viewing-angle diffusion film is disposed on the light emitting surface of the display panel. In the embodiment of the present application, the viewing angle of the light emitted from the light-emitting surface of the display panel is adjusted by the viewing-angle diffusion film, so as to improve the display performance of the display panel with a large viewing angle. Moreover, using the viewing-angle diffusion film to replace the existing viewing-angle expansion functional film layer can solve the issues of long mold manufacturing cycle, low efficiency, and poor yield in the existing manufacturing method of the viewing-angle expansion functional film layer.

### BRIEF DESCRIPTION OF THE DRAWINGS

In order to more clearly illustrate the technical solutions in the embodiments of the present application, the following briefly introduces the drawings that need to be used in the description of the embodiments. Apparently, the drawings in the following description are only some embodiments of the present application. For those skilled in the art, other drawings can also be obtained based on these drawings without any creative effort.

FIG. 1 is a schematic structural view of an existing viewing-angle expansion functional film layer.

FIG. 2 is a schematic structural view of a viewing-angle diffusion film provided by an embodiment of the present application.

FIG. 3 is a schematic structural diagram of an optical part provided by an embodiment of the present application.

FIG. 4 is a flowchart of a manufacturing method of a viewing-angle diffusion film provided by an embodiment of the present application.

FIG. 5A and FIG. 5B are structural process flowcharts for manufacturing the viewing-angle diffusion film in FIG. 4.

FIG. 6 is a schematic structural diagram of a display device provided by an embodiment of the present application.

### DETAILED DESCRIPTION

The technical solutions in the embodiments of the present application will be clearly and completely described below in conjunction with the drawings in the embodiments of the present application. Apparently, the described embodiments are only some of the embodiments of this application, not all of them. Based on the embodiments in this application, all other embodiments obtained by those skilled in the art without making creative efforts belong to the scope of protection of this application. In addition, it should be understood that the specific implementations described here are only used to illustrate and explain the present application and are not intended to limit the present application. In this application, unless stated to the contrary, the used orientation words such as “up” and “down” usually refer to up and down in the actual use or working state of the device, specifically the direction of the drawing in the drawings. The “inside” and “outside” refer to the outline of the installation.

Embodiments of the present application provide a viewing-angle diffusion film, a manufacturing method thereof, and a display device. Each will be described in detail below. It should be noted that the description sequence of the following embodiments is not intended to limit the preferred sequence of the embodiments.

Refer to FIG. 2 to FIG. 6, this embodiment provides a viewing-angle diffusion film, a manufacturing method thereof, and a display device. A display device 3 includes a display panel 3A and a viewing-angle diffusion film 2. The viewing-angle diffusion film 2 is located on the light emitting side of the display panel 3A. The viewing-angle diffusion film 2 includes an optical material layer 10 and a plurality of optical parts 21 disposed in the optical material layer 10. The optical material layer 10 has a light-emitting surface 2A and a light incident surface 2B that are oppositely arranged and parallel to each other. The plurality of the optical parts 21 are arranged in an array in the optical material layer 10, and each of the optical parts 21 has a long axis L and a short axis D intersecting each other. A refractive index n1 of the optical part 21 is greater than a refractive index n2 of the optical material layer 10. An angle α between the long axis L of the optical part 21 and the light-emitting surface 2A of the optical material layer 10 is greater than or equal to 0 degree and less than or equal to 45 degrees.

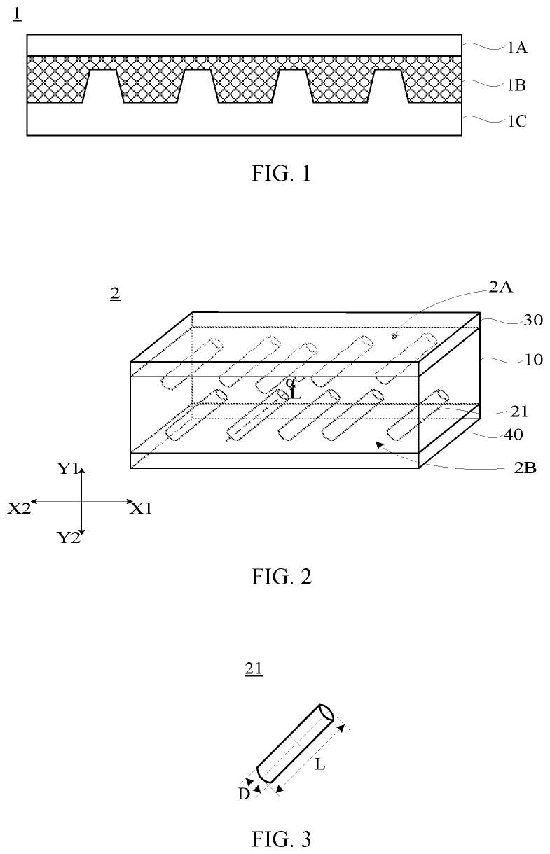

It should be noted that, in combination with FIG. 1, which is a schematic structural diagram of an existing viewing-angle expansion functional film layer. The existing viewing-angle expansion functional film layer 1 includes a base 1A, a first resin layer 1B located on the side of the base 1A, and a second resin layer 1C located on the side of the first resin layer away from the base 1A. In the prior art, the refractive index of the first resin layer 1B is set to be greater than the refractive index of the second resin layer 1C. When light enters the first resin layer 1B from the second resin layer 1C, the light enters from the optically thinner medium into the optically denser medium. The light may be refracted at the contact interface between the first resin layer 1B and the second resin layer 1C, thereby improving the display performance of the display panel 3A with a large viewing angle. In the traditional method of manufacturing the first resin layer 1B, it usually needs to use a nano-cutting machine tool for processing. Moreover, after the first resin layer 1B is formed by mold embossing, it is very easy to cause damage to the first resin layer 1B during the demolding process. Therefore, in the traditional method of manufacturing the existing viewing-angle expansion functional film layer 1, there are issues such as long mold manufacturing cycle, low efficiency, and poor yield, which seriously affect the mass production of products.

It can be understood that, in the embodiments of the present application, the viewing angle of the light emitted from the light emitting side of the display panel is adjusted by the viewing-angle diffusion film, so as to improve the large viewing angle display performance of the display panel. Moreover, using the viewing-angle diffusion film to replace the existing viewing-angle expansion functional film layer can solve the issues of long mold manufacturing cycle, low efficiency, and poor yield in the existing manufacturing method of the viewing-angle expansion functional film layer.

In an embodiment, refer to FIG. 2, which is a schematic structural diagram of the viewing-angle diffusion film provided by the embodiment of the present application.

In this embodiment, the viewing-angle diffusion film 2 is used to refract the light emitted from the light emitting side of the display panel 3A to the large viewing angle of the display panel 3A, and to refract the light emitted from the large viewing angle of the display panel 3A to the front of the display panel 3A. Through the simultaneous action of the above two aspects, the light emitted from the front and the light emitted from the large viewing angle are mixed, so as to achieve the same display performance under the front view and the large viewing angle. It should be noted that light with a large viewing angle may refer to light with a viewing angle greater than a preset angle (for example, 45 degrees), and light with a positive viewing angle may refer to light with a viewing angle smaller than a preset angle (for example, 20 degrees).

The viewing-angle diffusion film 2 includes an optical material layer 10 and a plurality of optical parts 21 disposed in the optical material layer 10. The material of the optical material layer 10 is a resin material, and the resin material includes but not limited to one of polyethylene, polypropylene, polyvinyl alcohol, polycarbonate, polyacrylic acid, or polyethylene terephthalate. The material of the optical part 21 includes but not limited to one of epoxy resin, acrylic resin, polyurethane resin, silicone resin, phenolic resin, or thermosetting resin. It can be understood that, in this embodiment, the optical material layer 10 is made of a resin material, and the material of the optical part 21 is made of a resin material, so as to increase the light transmission performance of the viewing-angle diffusion film 2.

In this embodiment, the direction from the light incident surface 2B to the light emitting surface 2A is the second direction Y1, and the direction from the light emitting surface 2A to the light incident surface 2B is the third direction Y2. The second direction Y1 is opposite to the third direction Y2, and the second direction Y1 forms a predetermined angle with the first direction X1. For ease of description, this embodiment proposes a fourth direction X2. The fourth direction X2 is opposite to the first direction X1.

It should be noted that, in this embodiment, there is no specific limitation on the first direction, the second direction, the third direction, the fourth direction, and the preset angle. However, for convenience of description, in this embodiment, the first direction is X1, the second direction is Y1, the third direction is Y2, the fourth direction is X2, and the preset angle is 90 degrees as an example. The technical scheme of the present application is illustrated. The positive viewing angle in this embodiment refers to viewing the viewing-angle diffusing film 2 along a direction from the light emitting surface 2A to the light incident surface 2B. The lower viewing angle refers to viewing the viewing-angle diffusion film 2 along a direction from the light incident surface 2B to the light emitting surface 2A.

A plurality of the optical parts 21 are arranged in an array in the optical material layer 10. The optical part 21 has a long axis L and a short axis D intersecting each other. The refractive index n1 of the optical part 21 is greater than the refractive index n2 of the optical material layer 10. The angle α between the long axis L and the light emitting surface 2A of the optical material layer 10 is greater than or equal to 0 degree and less than or equal to 45 degrees. The angle between the long axis L and the plane where the optical material layer 10 is located is preferably one of 0 degree, 10 degrees, 15 degrees, or 20 degrees.

It can be understood that, in the prior art, most of the light is vertically incident on the viewing-angle diffusion film 2. In this embodiment, the optical part 21 is located in the optical material layer 10, the angle α between the long axis L of the optical part 21 and the light emitting surface 2A of the optical material layer 10 is greater than or equal to 0 degree, and less than or equal to 45 degrees, so as to increase the contact area of the optical part 21 with the light. This further allows more light to be vertically incident on the optical part 21 from the optical material layer 10, thereby improving the utilization rate of the light that is vertically incident on the long axis L of the optical part 21. This diffuses the light to enhance its brightness at wide viewing angles. In addition, compared with the existing viewing-angle expansion functional film layer 1, the large viewing-angle display performance of the display panel 3A can be improved only through the combination of the two film layers. In this embodiment, by controlling the angle between the long axis L of the optical part 21 and the plane where the optical material layer 10 is located, the direction of the outgoing light of the display panel 3A in a front view and a large viewing angle can be adjusted, so as to avoid energy waste of the light in a front view of the display panel 3A.

Further, when light penetrates the optical material layer 10 and enters the optical part 21, and then enters the optical material layer 10 from the optical part 21, it enters from an optically denser medium to an optically thinner medium. By setting the refractive index n1 of the optical part 21 to be greater than the refractive index n2 of the optical material layer 10, light may be refracted at the contact interface between the optical material layer 10 and the optical part 21. Therefore, at least part of the incident light at a normal viewing angle can be adjusted to light at a large viewing angle, so as to enhance the brightness of the light at a large viewing angle.

In this embodiment, the shape of the optical part 21 includes but not limited to a cylindrical shape. A plurality of optical parts 21 are arranged in an array in the optical material layer 10, and the extending directions of the long axes L of the plurality of optical parts 21 are parallel to each other. Preferably, the extending direction of the long axis L of the optical part 21 is perpendicular to the extending direction of the short axis D of the optical part 21. The shape of the optical part 21 is cylindrical. A plurality of the optical parts 21 are arranged along the first direction X1. It can be understood that, in this embodiment, the shape of the optical part 21 is set as a cylinder. The plurality of optical parts 21 are arranged along the first direction X1, and the first direction X1 is perpendicular to the second direction Y1. Based on the arrangement direction, light diffuses in a horizontal direction (first direction X1 and fourth direction X2), while its vertical direction (second direction Y1 and third direction Y2) decreases. This further avoids loss of brightness of the light at the normal viewing angle.

Further, refer to FIG. 2 and FIG. 3, wherein FIG. 3 is a schematic structural diagram of the optical part provided by the embodiment of the present application.

In this embodiment, the ratio of the long axis L of the optical part 21 to the short axis D of the optical part 21 is greater than 5 and less than 30. The length of the short axis D of the optical part 21 is greater than 0.8 microns, and the length of the long axis L of the optical part 21 is smaller than the thickness of the optical material layer 10. Preferably, the length of the short axis D of the optical part 21 is 2 micrometers, and the length of the long axis L of the optical part 21 only needs to meet the above conditions. It can be understood that, in the display panel 3A, the enlargement of the viewing angle may lead to the decrease of the front brightness. Therefore, in this embodiment, the length of the short axis D of the optical part 21 is set to be greater than 0.8 μm, and the length of the long axis L of the optical part 21 is smaller than the thickness of the optical material layer 10 to enhance the brightness of light under large viewing angles. This improves the viewing-angle widening effect of the viewing-angle diffusion film 2. In addition, it realizes the directional adjustment of the outgoing light of the front view and the large viewing angle and avoids the energy waste of the light at the front view angle and the downward view angle.

In this embodiment, the refractive index n1 of the optical part 21 is greater than or equal to 1.4 and less than or equal to 1.7. The refractive index n2 of the optical material layer 10 is greater than or equal to 1.3 and less than or equal to 1.6. Further, the range of the difference between the refractive index n1 of the optical part 21 and the refractive index n2 of the optical material layer 10 is larger than 0.02. The refractive index n1 of the optical part 21 is preferably 1.6, and the refractive index n2 of the optical material layer 10 is preferably 1.4. The difference between the refractive index n1 of the optical part 21 and the refractive index n2 of the optical material layer 10 is preferably 0.1.

It should be noted that in this embodiment, the refractive index n1 of the optical part 21 is set to be greater than or equal to 1.4 and less than or equal to 1.7, and the refractive index n2 of the optical material layer 10 is greater than or equal to 1.3 and less than or equal to 1.6, thereby avoiding the energy waste of the light at the front viewing angle and the downward viewing angle. That is, the diffusion of light in the second direction Y1 and the third direction Y2 is blocked. Moreover, the range of the difference between the refractive index n1 of the optical part 21 and the refractive index n2 of the optical material layer 10 is controlled to be greater than 0.02, so as to enhance the brightness of the light at a large viewing angle. This improves the viewing angle expansion effect of the viewing angle diffuser film 2, and further avoids the energy waste of light at the front viewing angle and the downward viewing angle. That is, the effect of blocking the diffusion of light in the second direction Y1 and the third direction Y2 is increased.

Further, in this embodiment, in two adjacent optical parts 21, the orthographic projection of one optical part 21 on the light incident surface 2B of the optical material layer 10 at least partially overlaps the orthographic projection of the other optical part 21 on the light incident surface 2B of the optical material layer 10. Therefore, the contact area between the optical part 21 and the light is increased, so that more light is vertically incident into the optical part 21 from the optical material layer 10, and the viewing angle expansion effect of the viewing-angle diffusion film 2 is improved. It should be noted that the overlapping portion of the orthographic projections of two adjacent optical parts 21 on the optical material layer 10 is only for illustration. In another embodiment, the orthographic projections of two adjacent optical parts 21 on the optical material layer 10 have gaps.

In this embodiment, the viewing-angle diffusion film 2 further includes a protective film layer 30 located on the side of the light emitting surface 2A of the optical material layer 10. The protective film layer 30 includes but not limited to one or more of an anti-scratch layer (HC), an anti-glare layer (AG) and a low reflection layer (LR). It can be understood that, in this embodiment, stability of the material of the optical part 21 can be improved by disposing the protective film layer 30 on the light emitting surface 2A of the optical material layer 10, and this can further improve the viewing-angle expansion effect of the viewing-angle diffusion film 2.

It can be understood that when the viewing-angle diffusion film 2 is used to refract the light emitted from the front of the display panel 3A to the large viewing angle of the display panel 3A, the viewing-angle diffusion film 2 further includes an adhesive layer 40 located on the side of the light incident surface 2B of the optical material layer 10, and the adhesive layer 40 is used to attach the optical material layer 10 to the light emitting side of the display panel 3A.

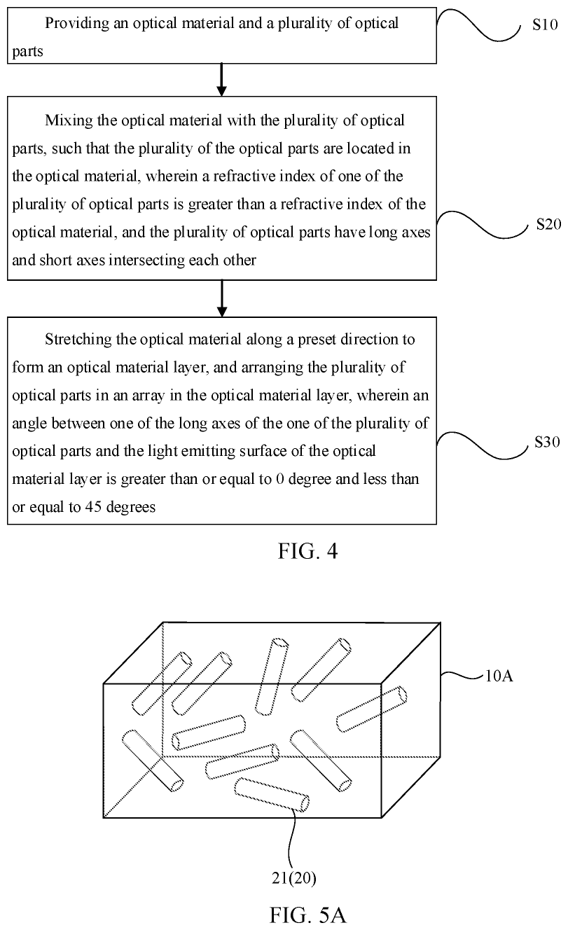

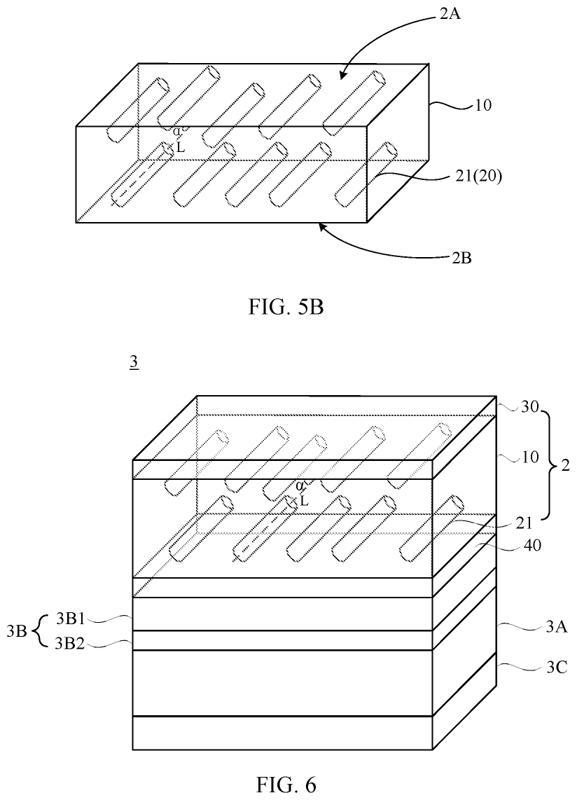

This embodiment also provides a manufacturing method of the viewing-angle diffusion film. Refer to FIG. 2, FIG. 4, FIG. 5A, and FIG. 5B, wherein FIG. 4 is a flowchart of a manufacturing method of a viewing-angle diffusion film provided by an embodiment of the present application, and FIG. 5A and FIG. 5B are structural process flowcharts for manufacturing the viewing-angle diffusion film in FIG. 4.

In this embodiment, the manufacturing method of the viewing-angle diffusion film includes the following steps:

Step S10: Providing an optical material 10A and a plurality of optical parts 21.

The optical material 10A is a resin material. The resin material includes but not limited to one of polyethylene, polypropylene, polyvinyl alcohol, polycarbonate, polyacrylic acid, or polyethylene terephthalate. The material of the optical part 21 includes but not limited to one of epoxy resin, acrylic resin, polyurethane resin, silicone resin, phenolic resin, or thermosetting resin.

Step S20: Mixing the optical material 10A with a plurality of the optical parts 21, so that the plurality of optical parts 21 are located in the optical material 10A, wherein the refractive index n1 of the optical part 21 is greater than the refractive index n2 of the optical material 10A, and the optical part 21 has a long axis L and a short axis D intersecting each other, as shown in FIG. 5A.

In this embodiment, the shape of the optical part 21 includes but not limited to a cylindrical shape. Preferably, the extending direction of the long axis L of the optical part 21 is perpendicular to the extending direction of the short axis D of the optical part 21, and the shape of the optical part 21 is cylindrical.

Specifically, the ratio of the long axis L of the optical part 21 to the short axis D of the optical part 21 is greater than 5 and less than 30. The length of the short axis D of the optical part 21 is greater than 0.8 microns, and the length of the long axis L of the optical part 21 is smaller than the thickness of the optical material layer 10. Preferably, the length of the short axis D of the optical part 21 is 2 micrometers, and the length of the long axis L of the optical part 21 only needs to meet the above conditions. It can be understood that in this embodiment, the ratio of the long axis L of the optical part 21 to the short axis D of the optical part 21 is controlled to be greater than 5 and less than 30. Therefore, the volume of the optical part 21 is controlled, which is beneficial to the mixing of the optical part 21 and the optical material.

Step S30: Stretching the optical material 10A along a predetermined direction to form an optical material layer 10, and arranging a plurality of optical parts 21 in an array in the optical material layer 10, wherein the angle between the long axis L of the optical part 21 and the light emitting surface 2A of the optical material layer 10 is greater than or equal to 0 degree and less than or equal to 45 degrees, as shown in FIG. 5B.

It should be noted that, in this embodiment, the technical solution of the present application is illustrated by taking the preset direction as the first direction X1 as an example. In the step S30, the optical material 10A is stretched along a preset direction to form an optical material layer 10, and a plurality of the optical parts 21 are arranged along the preset direction.

In this embodiment, the stretching ratio of the optical material is greater than 1.01. It can be understood that, in this embodiment, by setting the stretch ratio of the optical material to be greater than 1.01, a plurality of the optical parts 21 are all arranged along the first direction X1.

It can be understood that, in the traditional method of manufacturing the existing viewing-angle expansion functional film layer 1, it is usually necessary to use a nano-cutting machine tool for processing. Moreover, after the existing functional film layer 1 for expanding the viewing angle is formed by mold embossing, it is very easy to cause damage to the existing functional film layer 1 for expanding the viewing angle during the demolding process. Therefore, in the traditional method of manufacturing the existing viewing-angle expansion functional film layer 1, there are issues such as long mold manufacturing cycle, low efficiency, and poor yield, which seriously affect the mass production of products. In this embodiment, the optical material layer 10 is formed by stretching the optical material along the first direction X1, and a plurality of the optical parts 21 are all arranged along the first direction X1. The angle between the long axis L of the optical part 21 and the plane where the optical material layer 10 is located is greater than or equal to 0 degrees and less than or equal to 45 degrees, thereby avoiding the use of nano-cutting machine tools. This can solve the issues of long mold manufacturing cycle, low efficiency, and poor yield in the existing method for manufacturing the viewing-angle expansion functional film layer 1.

Further, in this embodiment, the optical part 21 is located in the optical material layer 10 by setting. The angle between the long axis L of the optical part 21 and the plane where the optical material layer 10 is located is greater than or equal to 0 degree and less than or equal to 45 degrees. Thus, the contact area of the optical part 21 and the light is increased. This further allows more light to be vertically incident on the optical part 21 from the optical material layer 10, thereby improving the utilization rate of the light that is vertically incident on the long axis L of the optical part 21. This diffuses the light to enhance its brightness at wide viewing angles. In addition, compared with the existing viewing-angle expansion functional film layer 1, the large viewing angle display effect of the display panel 3A can be improved only through the combination of the two film layers. In this embodiment, by controlling the angle between the long axis L of the optical part 21 and the plane where the optical material layer 10 is located, the orientation of the light emitted by the display panel 3A in front view and at a large viewing angle can be adjusted. This avoids the energy waste of the light in the normal viewing angle of the display panel 3A.

This embodiment also provides a display device. Refer to FIG. 2 and FIG. 6, wherein FIG. 6 is a schematic structural diagram of the display device provided by the embodiment of the present application.

This embodiment provides a display device. The display device 3 includes a display panel 3A and the viewing-angle diffusion film 2 described in any of the above-mentioned embodiments.

It can be understood that, the viewing-angle diffusion film 2 has been described in detail in the above embodiments, and will not be repeated here.

In this embodiment, the display device 3 further includes a first polarizer 3B located between the viewing-angle diffusion film 2 and the display panel 3A and a second polarizer 3C located on the side of the display panel 3A away from the viewing-angle diffusion film 2. The first polarizer 3B includes a protective layer 3B2 disposed on the display panel 3A and a polarizing layer 3B1 located on a side of the protective layer 3B2 away from the display panel 3A. The adhesive layer 40 is used to attach the optical material layer 10 to the side of the polarizing layer 3B1 away from the display panel 3A.

It can be understood that, in the prior art, most of the light is vertically incident on the polarizer from the display panel 3A. In this embodiment, the optical part 21 is located in the optical material layer 10. The angle between the long axis L of the optical part 21 and the plane where the optical material layer 10 is located is greater than or equal to 0 degree and less than or equal to 45 degrees. Therefore, the contact area between the optical part 21 and the light is increased, and more light is vertically incident into the optical part 21 from the optical material layer 10. This improves the utilization rate of the light perpendicular to the long axis L direction of the optical part 21, so that the light is diffused, so as to enhance the brightness of the light at a large viewing angle.

It should be noted that, in the prior art, the polarizer usually includes a first protective layer and a second protective layer opposite to each other, and a polarizing layer located between the first protective layer and the second protective layer. In this embodiment, the viewing-angle diffusion film 2 is arranged on the side of the first polarizer 3B1 away from the protective layer 3B2, so as to protect the polarizer and further simplify the structure of the display device 3.

In a specific application, the display device 3 may be a display screen of a smartphone, a tablet, a laptop, a smart bracelet, a smart watch, smart glasses, a smart helmet, a desktop computer, a smart TV, or a digital camera, and may even be applied to an electronic device with a flexible display screen.

To sum up, the present application provides a viewing-angle diffusion film, a manufacturing method thereof, and a display device. The display device includes a display panel and the viewing-angle diffusion film. The viewing-angle diffusion film is located on the light emitting side of the display panel. In the embodiments of the present application, the viewing angle of the light emitted from the light emitting side of the display panel is adjusted by the viewing-angle diffusion film, so as to improve the display performance of the display panel with a large viewing angle. Moreover, using the viewing-angle diffusion film to replace the existing viewing-angle expansion functional film layer can solve the issues of long mold manufacturing cycle, low efficiency, and poor yield in the existing manufacturing method of the viewing-angle expansion functional film layer.

In the foregoing embodiments, the descriptions of each embodiment have their own emphases. For parts not described in detail in a certain embodiment, reference may be made to relevant descriptions of other embodiments.

The viewing-angle diffusion film provided in the embodiments of the present application, its manufacturing method, and display device are described in detail above. In this description, specific examples are used to illustrate the principles and implementation methods of the present application. The descriptions of the above embodiments are only used to help understand the method and the core idea of the present application. In addition, for those skilled in the art, there will be changes in specific implementation methods and application scopes based on the idea of the present application. To sum up, the contents of this specification should not be understood as limiting the present application.

What is claimed is:

1. A viewing-angle diffusion film, comprising:
an optical material layer having a light emitting surface and a light incident surface disposed opposite to each other and parallel to each other;
a plurality of optical parts disposed in an array in the optical material layer, wherein the plurality of optical parts have long axes and short axes intersecting each other;
wherein a refractive index of each of the plurality of optical parts is greater than a refractive index of the optical material layer, and an angle between each of the long axes of each of the plurality of optical parts and the light emitting surface of the optical material layer is greater than or equal to 0 degree and less than or equal to 45 degrees.

2. The viewing-angle diffusion film of claim 1, wherein a shape of each of the plurality of optical parts is cylindrical, the plurality of the optical parts are disposed in an array in the optical material layer, and extending directions of the long axes of the plurality of the optical parts are parallel to each other.

3. The viewing-angle diffusion film of claim 2, wherein a ratio of a length of each of the long axes of each of the plurality of optical parts to a length of each of the short axes of each of the plurality of optical parts is greater than 5 and less than 30, wherein the length of each of the short axes of each of the plurality of optical parts is greater than 0.8 microns, and the length of each of the long axes of each of the plurality of optical parts is less than a thickness of the optical material layer.

4. The viewing-angle diffusion film of claim 1, wherein the refractive index of each of the plurality of optical parts is greater than or equal to 1.4 and less than or equal to 1.7, and the refractive index of the optical material layer is greater than or equal to 1.3 and less than or equal to 1.6.

5. The viewing-angle diffusion film of claim 4, wherein a range of a difference between the refractive index of each of the plurality of optical parts and the refractive index of the optical material layer is greater than 0.02.

6. The viewing-angle diffusion film of claim 1, wherein in two adjacent ones of the plurality of optical parts, an orthographic projection of each of the plurality of optical parts on a light incident surface of the optical material layer and an orthographic projection of another of the plurality of optical parts on the light incident surface of the optical material layer are at least partially overlap.

7. The viewing-angle diffusion film of claim 1, wherein a material of the optical material layer is one of polyethylene, polypropylene, polyvinyl alcohol, polycarbonate, polyacrylic acid, or polyethylene terephthalate.

8. A manufacturing method of a viewing-angle diffusion film, comprising following steps:
providing an optical material and a plurality of optical parts;
mixing the optical material with the plurality of optical parts, such that the plurality of the optical parts are located in the optical material, wherein a refractive index of each of the plurality of optical parts is greater than a refractive index of the optical material, and the plurality of optical parts have long axes and short axes intersecting each other;
stretching the optical material along a preset direction to form an optical material layer, and arranging the plurality of optical parts in an array in the optical material layer, wherein an angle between each of the long axes of each of the plurality of optical parts and the light emitting surface of the optical material layer is greater than or equal to 0 degree and less than or equal to 45 degrees.

9. The manufacturing method of the viewing-angle diffusion film of claim 8, wherein a stretching ratio of the optical material is greater than 1.01.

10. A display device, comprising:
a display panel; and
a viewing-angle diffusion film disposed on a light emitting surface of the display panel, wherein the viewing-angle diffusion film, comprising:
an optical material layer having a light emitting surface and a light incident surface disposed opposite to each other and parallel to each other;
a plurality of optical parts disposed in an array in the optical material layer, wherein the plurality of optical parts have long axes and short axes intersecting each other;
wherein a refractive index of each of the plurality of optical parts is greater than a refractive index of the optical material layer, and an angle between each of the long axes of each of the plurality of optical parts and the light emitting surface of the optical material layer is greater than or equal to 0 degree and less than or equal to 45 degrees.

11. The display device of claim 10, wherein a shape of each of the plurality of optical parts is cylindrical, the plurality of the optical parts are disposed in an array in the optical material layer, and extending directions of the long axes of the plurality of the optical parts are parallel to each other.

12. The display device of claim 11, wherein a ratio of a length of each of the long axes of each of the plurality of optical parts to a length of each of the short axes of each of the plurality of optical parts is greater than 5 and less than 30, wherein the length of each of the short axes of each of the plurality of optical parts is greater than 0.8 microns, and the length of each of the long axes of each of the plurality of optical parts is less than a thickness of the optical material layer.

13. The display device of claim 10, wherein the refractive index of each of the plurality of optical parts is greater than or equal to 1.4 and less than or equal to 1.7, and the refractive index of the optical material layer is greater than or equal to 1.3 and less than or equal to 1.6.

14. The display device of claim 13, wherein a range of a difference between the refractive index of each of the plurality of optical parts and the refractive index of the optical material layer is greater than 0.02.

15. The display device of claim 10, wherein in two adjacent ones of the plurality of optical parts, an orthographic projection of each of the plurality of optical parts on a light incident surface of the optical material layer and an orthographic projection of another of the plurality of optical parts on the light incident surface of the optical material layer are at least partially overlap.

16. The display device of claim 10, wherein a material of the optical material layer is one of polyethylene, polypropylene, polyvinyl alcohol, polycarbonate, polyacrylic acid, or polyethylene terephthalate.
